(19) United States
(12) Patent Application Publication
(10) Pub. No.: US 2007/0099467 A1
(43) Pub. Date: May 3, 2007

(54) Engagement sensing system and method for same

(76) Inventors: Rene I. Jager, Davie, FL (US); Peter B. Gilmore, Plantation, FL (US); Charles E. Kline, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/263,706

(22) Filed: Nov. 1, 2005

(51) Int. Cl. H01R 13/15

(52) U.S. Cl. 439/260

(57) ABSTRACT

The invention concerns an engagement sense pin system (200) and a method (400) for same. The system can include a circuit (210) having an end (214) in which the end can include a plurality of pins (216), at least one of which may be a sense pin (218), and a connector (212) that can receive the end of the circuit. The connector can include a set of contacts (220) that may correspond to the pins of the circuit. Also, the sense pin can have a length that is shorter than a number of the remaining pins of the circuit. When the contact receives the sense pin, the engagement between the circuit and the connector may be deemed sufficient. The system can also include a detection mechanism (224) that can detect the receipt of the sense pin of the circuit by the contact of the connector.

### BACKGROUND OF THE INVENTION

1. Field of the Invention

The present invention concerns maintaining manufacturing quality and more particularly, ensuring that connections between components are properly engaged.

2. Description of the Related Art

Many electrical devices include flexible circuits (“flex circuit”) and corresponding zero insertion force (ZIF) connectors. The flex circuit typically includes a number of pins positioned at the end of the flex circuit, and the ZIF connector includes contacts that contact the pins of the flex circuit when the flex circuit is properly engaged with the ZIF connector. In particular, the end of the flex circuit containing the pins is inserted in the ZIF connector, and a bar or door on the ZIF connector is pressed downward. As it is pressed downward, the bar forces the pins of the flex circuit to contact the contacts of the ZIF connector. This process is generally performed manually.

During this process, however, the flex circuit may not be properly engaged with the ZIF connector. Even so, the improper engagement may not be initially detected because the pins of the flex circuit are still in sufficient contact with the contacts of the ZIF connector, at least as determined by initial testing. Over time, however, because of the improper engagement, the flex circuit may dislodge from the ZIF connector, which will cause the pins to lose contact with the contacts. As a result, this disengagement will negatively affect the performance of the radio.

### SUMMARY OF THE INVENTION

The present invention concerns an engagement sense pin system. The system can include a circuit having an end, in which the end can include a plurality of pins, at least one of which may be a sense pin, and a connector that can receive the end of the circuit. The connector can include a set of contacts corresponding to the pins of the circuit. In one arrangement, the sense pin can have a length that can be shorter than a number of the remaining pins of the circuit. As such, when the contact receives the sense pin, the engagement between the circuit and the connector may be deemed sufficient.

The system can also include a detection mechanism that can detect the receipt of the sense pin of the circuit by the contact of the connector. In addition, the circuit can include at least two sense pins that may be electrically coupled to one another. The detection mechanism can detect the receipt of the sense pins by the contacts by determining whether a closed electrical path exists between the sense pins and the contacts.

In another arrangement, the sense pin of the circuit may be electrically coupled to a pin having a predetermined setting. The sense pin can also have the predetermined setting through the electrical coupling, and the detection mechanism can detect the receipt of the sense pin by the contact by detecting the predetermined setting on the sense pin. As an example, the predetermined setting can be a supply voltage.

As another example, the circuit can include at least two sense pins, and the plurality of pins can include a first end and a second end. One sense pin may be positioned at the first end, and another sense pin may be positioned at the second end. In one arrangement, the connector can be a zero insertion force connector, and the circuit can be a flexible circuit. Additionally, the system may be contained within a mobile communications unit.

The present invention also concerns a method of determining whether a circuit is properly engaged with a connector. The method can include the step of coupling an end of a flexible circuit having a plurality of pins—at least one of which may be a sense pin having a length shorter than a number of the remaining pins—to a connector having a set of contacts corresponding to the pins of the flexible circuit. The method may also include the step of determining whether the contact receives the sense pin. When the contact receives the sense pin, the coupling between the flexible circuit and the connector may be deemed sufficient.

As an example, the flexible circuit can include at least two sense pins and determining whether the contact receives the sense pin can include determining whether a closed electrical path exists between the sense pins and the contacts. As another example, the sense pin of the circuit can be electrically coupled to a pin having a predetermined setting in which the sense pin may also have the predetermined setting through the electrical coupling. Determining whether the contact receives the sense pin can include detecting the predetermined setting on the sense pin.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a mobile communication unit in accordance with an embodiment of the inventive arrangements;

FIG. 2 illustrates an engagement sensing system in accordance with an embodiment of the inventive arrangements;

FIG. 3 illustrates examples of an end of a flexible circuit and a connector in accordance with an embodiment of the inventive arrangements; and

FIG. 4 illustrates a method for determining whether a circuit is properly engaged with a connector in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” and “engagement,” as used herein, are defined as connected, although not necessarily directly, and not necessarily mechanically. The term “module” can be defined as any combination of hardware and/or software to enable an appropriate function to be performed.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns an engagement sense pin system. The system can include a circuit, such as a flexible circuit, having an end in which the end may include a plurality of pins, at least one of which may be a sense pin. The system can also have a connector that can receive the end of the circuit, and the connector can include a set of contacts that can correspond to the pins of the circuit. In one arrangement, the sense pin may have a length that can be shorter than a number of the remaining pins of the circuit. As such, when the contact receives the sense pin, the engagement between the circuit and the connector may be deemed sufficient.

The system may also include a detection mechanism that can detect the receipt of the sense pin of the circuit by the contact of the connector. Because the connections between the sense pins and the contacts of the connector are more difficult to achieve given the shorter length of the sense pins as compared to the remaining pins, the connections between the sense pins and the contacts can provide an indication that the flexible circuit is properly engaged with the connector.

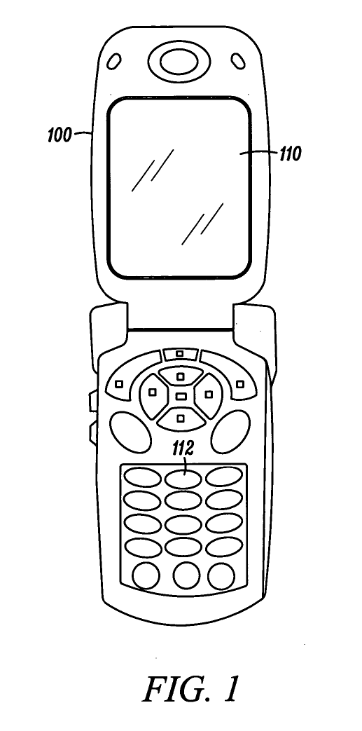

Referring to FIG. 1, a mobile communication device 100 is shown. As an example, the mobile communication device 100 can include a display 110 and a keypad 112. The device 100 can be, for example, a cellular telephone, a two-way radio or a personal digital assistant (PDA), although the device 100 is in no way limited to these examples.

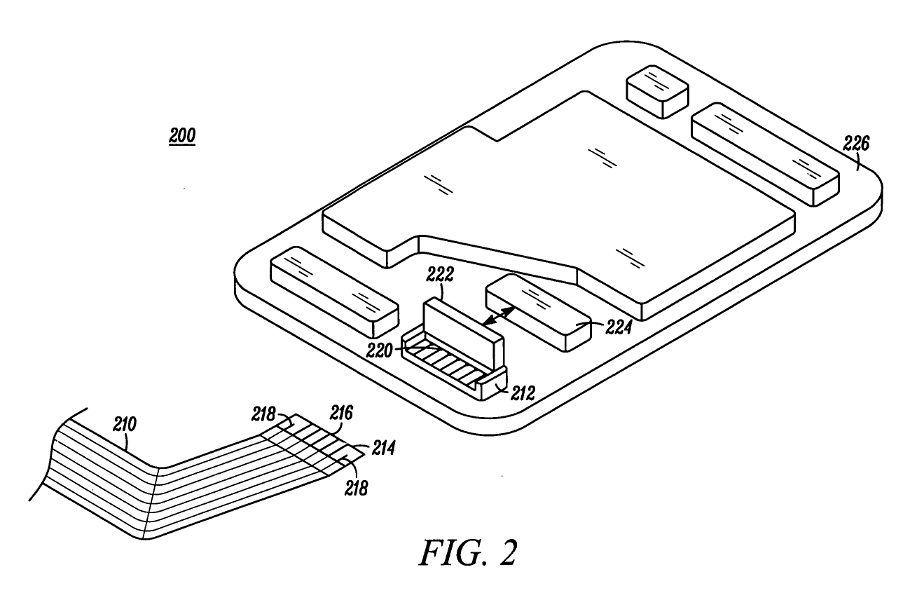

Referring to FIG. 2, an engagement sensing system 200 is shown. As an example, the system 200 can be incorporated in the device 100 of FIG. 1. It is understood, however, that the system 200 can be part of any other suitable electrical device. The system 200 can include a circuit 210 and a connector 212 that can receive the circuit 210. As an example, the circuit 210 can be a flexible circuit, and the connector 212 can be a ZIF connector, although the invention is not limited to either of these.

In one arrangement, the flex circuit 210 can have an end 214 that can include a plurality of pins 216. In addition, the connector 212 can include a plurality of contacts 220, which may correspond to the pins 216. As is known in the art, signals can pass through the flex circuit 210 and through the pins 216 to the contacts 220 of the connector 212 when the connector 212 receives the end 214 of the flex circuit 210. In one particular arrangement, one or more of the pins 216 can be sense pins 218. As will be described further below, the sense pins 218 may have a length that is shorter than a number of the remaining pins 216.

The end 214 of the of the flex circuit 210 may be inserted in the connector 212. As can be seen, the connector 212, because it may be a ZIF connector, can include a door 222. When the end 214 of the flex circuit 210 is placed in the connector 212, the door 222 can be closed. Because of its design, the door 222 can force the end 214 of the flex circuit 210 towards the contacts 220, which can cause the contacts 220 to receive the pins 216. In addition, the contacts 220 may also receive the sense pins 218. For purposes of the invention, the contacts 220 receiving the pins 216 and sense pins 218 can mean that the connection between the contacts 220 and the pins 216 or sense pins 218 is sufficient enough to enable signals to pass through them.

The system 200 may also include a detection mechanism 224, which can be coupled to the connector 212. As an example, the detection mechanism 224 can detect the receipt of the sense pins 218 of the flexible circuit 210 by the contacts 220 of the connector 212. There are several ways for the detection mechanism 224 to perform this process, and several examples will be presented below. When the detection mechanism 224 determines that the appropriate contacts 220 have received the sense pins 218, the detection mechanism 224 can determine that the engagement between the flex circuit 210 and the connector 220 is sufficient. That is, when the contacts 220 receive the sense pins 218, the engagement between the flex circuit 210 and the connector 212 can be acceptable.

When the receipt is detected, the detection mechanism 224 can signal any other suitable device or component to indicate the acceptable engagement between the flex circuit 210 and the connector 212. Conversely, if the detection mechanism 224 does not detect the contacts 220 receiving the sense pins 218, the detection mechanism 224 can signal the device or component that the engagement between the flex circuit 210 and the connector 212 is not acceptable. Any suitable type of corrective action may be performed at this point. The detection mechanism 224 can be any suitable component capable of determining whether the contacts 220 have received the sense pins 218, or whether the engagement between the flex circuit 210 and the connector is acceptable, and signaling some other component to indicate such determination. As an example, the detection mechanism 224 can be a logic circuit or a processor.

In one arrangement, the connector 212 and the detection mechanism 224 can be positioned on a printed circuit board (PCB) 226 of the mobile communication device 100 or some other electronic device. Of course, these components can be positioned on any other suitable surface. It must be noted that the detection mechanism 224 is not limited to being located in the device 100, as the detection mechanism 224 can be positioned outside the device 100.

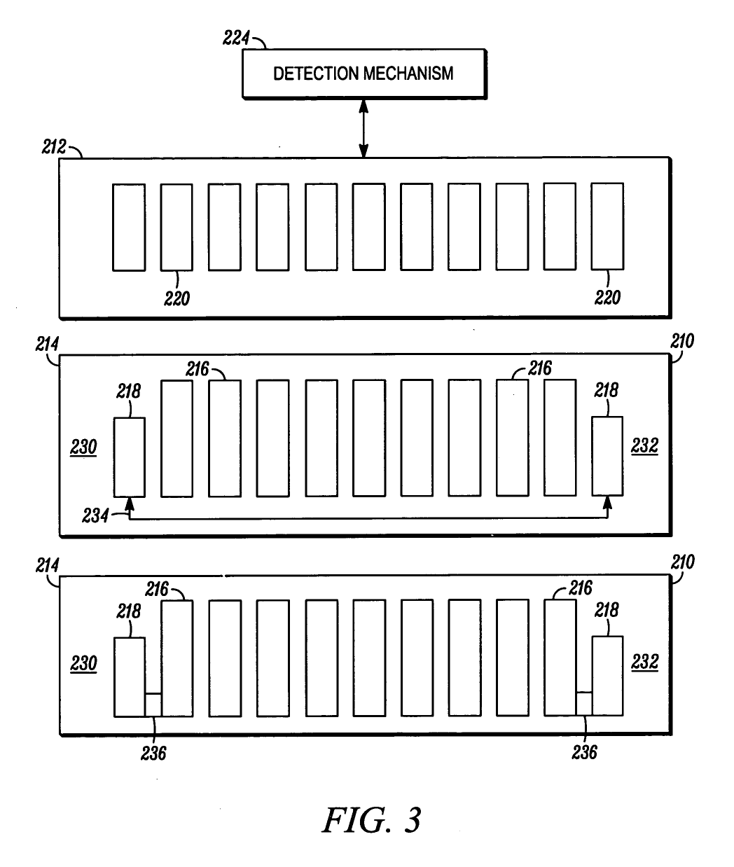

Referring to FIG. 3, a closer view of the connector 212, the detection mechanism 224 and several examples of the end 214 of the flex circuit 210 is shown. As can be seen, the detection mechanism 224 can be coupled to the connector 212, and the contacts 220 of the connector 212 can receive the pins 216 of the flex circuits 210. In the flex circuit 210 closest to the connector 212, the plurality of pins 216 can have a first end 230 and a second end 232. In one arrangement, this flex circuit 210 can have two sense pins 218, one of which can be positioned at the first end 230 and the other can be positioned at the second end 232.

The sense pins 218 in this example can be shorter than the rest of the pins 216. The sense pins 218 can be shorter than the remaining pins 216 by any suitable distance, although the shorter they are in comparison to the remaining pins 216, the more accurate the determination of acceptable engagement between the flex circuit 210 and the connector 212 may be. In addition, the sense pins 218 can be electrically coupled by a path 234. As the connector 212 receives the flex circuit 210, the contacts 220 can receive the longer pins 216 first and can eventually receive the shorter sense pins 218.

During this process, the detection mechanism 224 can detect the receipt of the sense pin 218 by the contact 220. For example, because the sense pins 218 may be connected by the path 234, the detection mechanism 224 can determine whether a closed electrical path exists between the sense pins 218 and the contacts 220. Because the sense pins 218 may be shorter than the remaining pins 216, this electrical connection can ensure that the remaining pins 216 are in suitable contact with the contacts 220. As such, the engagement between the flex circuit 210 and the connector 212 can be deemed sufficient, and the detection mechanism 224 can indicate this detection, as described above. If the contacts 220 have not received one or more of the sense pins 218, then the closed electrical path may not exist, and the engagement may not be deemed sufficient.

The component located at the bottom of FIG. 3 also shows another example of the end 214 of the flex circuit 210. In this arrangement, the sense pins 218 may be electrically connected to one or more of the remaining pins 216 through an electrical connection 236. The pins 216 to which the sense pins 218 are connected may have a predetermined setting. For example, the pin 216 electrically coupled to the sense pin 218 may be a pin that carries a supply voltage or some other signal. Thus, because it is electrically connected to the pin 216 having the predetermined setting, the sense pin 218 may also have this predetermined setting. In this example, the sense pin 218 may carry the supply voltage or other suitable signal. As a result, the detection mechanism 224 can detect the receipt of the sense pin 218 by the contact 220 by detecting the predetermined setting on the sense pin 218. If the detection mechanism 224 does not detect the predetermined setting on the sense pin 218, then the contact 220 may not have received the sense pin 218, which may indicate that the flex circuit 210 and the connector 212 are not properly engaged. These sense pins 218 may also be positioned at the first end 230 and the second end 232.

The predetermined setting can be associated with any suitable signal that one or more of the pins 216- to which the sense pins 218 are electrically coupled—may carry. The predetermined setting can be an actual setting or condition that presently exists on the relevant pin 216 or a setting that may be present at some future time on the pin 216. Similar to the process described above, the detection mechanism 224 can signal an appropriate component when it determines whether the sense pin 218 has the predetermined setting.

Although several examples of flex circuits 210 having sense pins 218 have been presented here, the invention is in no way limited to them. For example, it is not necessary to position the sense pins 218 at the first end 230 and/or second end 232, as the sense pins 218 can be placed at any other suitable location in relation to the remaining pins 216. Moreover, the flex circuits 210 can include any suitable number of sense pins 218, including just one or more than two. In addition, it is not necessary that the sense pins 218 be shorter than every pin 216, as the number of pins 216 that are longer than the sense pins 218 can be any suitable count. Those of skill in the art will also appreciate that there are many other ways to detect whether the contacts 220 have received the sense pins 218.

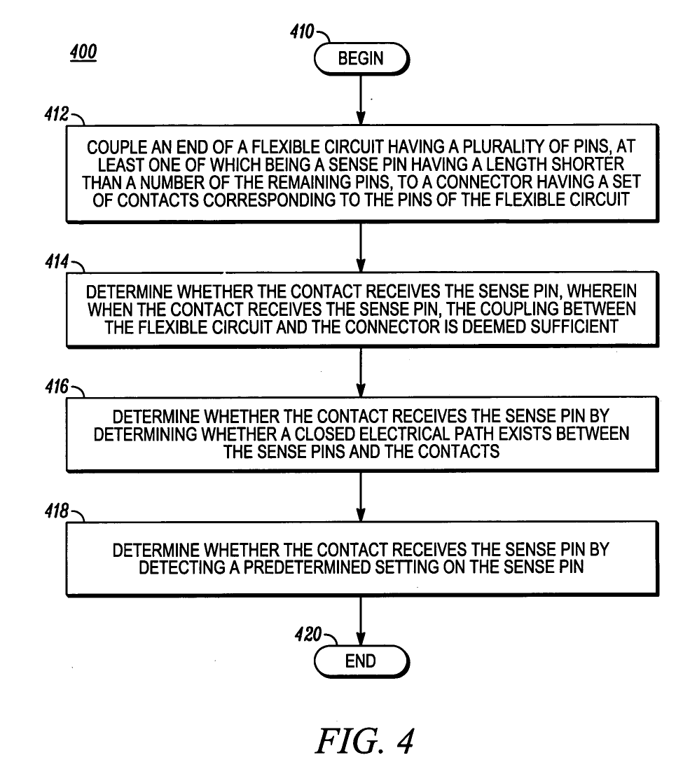

Referring to FIG. 4, a method 400 for determining whether a circuit is properly engaged with a connector is shown. When describing the method 400, reference will be made to FIGS. 2 and 3, although it must be noted that the method 400 can be practiced in any other suitable system or device. Moreover, the steps of the method 400 are not limited to the particular order in which they are presented in FIG. 4. The inventive method can also have a greater number of steps or a fewer number of steps than those shown in FIG. 4.

At step 410, the method can begin. At step 412, an end of a flexible circuit having a plurality of pins, at least one of which being a sense pin having a length shorter than a number of the remaining pins, can be coupled to a connector having a set of contacts corresponding to the pins of the flexible circuit. For example, referring to FIGS. 2 and 3, the flex circuit 210 can be inserted in the connector 212, and the door 222 of the connector 212 can be shut, which can force the sense pins 218 to contact the appropriate contacts 220.

Referring back to FIG. 4, at step 414, it can be determined whether the contact has received the sense pin. If and when the contact receives the sense pin, the coupling between the flexible circuit and the connector can be deemed sufficient. For example, this determining process can be performed by determining whether a closed electrical path exists between the sense pins and the contacts and/or by detecting a predetermined setting on the sense pin.

For example, referring once again to FIGS. 2 and 3, the detection mechanism 224 can determine whether the contacts 220 have received the sense pins 218. As described earlier, the detection mechanism 224 can determine whether a closed electrical path exists between the sense pins 218 and the contacts 220 or by detecting a predetermined setting on the sense pins 218. It is understood that these examples of detection are not exclusive of one another. In particular, the flex circuit 210 can be designed such that the detection mechanism 224 can detect the closed electrical path between sense pins 218 and the predetermined setting on the sense pins 218.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An engagement sense pin system, comprising:
a circuit having an end, wherein the end includes a plurality of pins, at least one of which being a sense pin; and
a connector that receives the end of the circuit, wherein the connector includes a set of contacts corresponding to the pins of the circuit;
wherein the sense pin has a length that is shorter than a number of the remaining pins of the circuit and when the contact receives the sense pin, the engagement between the circuit and the connector is deemed sufficient.

2. The system according to claim 1, further comprising a detection mechanism that detects the receipt of the sense pin of the circuit by the contact of the connector.

3. The system according to claim 2, wherein the circuit includes at least two sense pins that are electrically coupled to one another, wherein the detection mechanism detects the receipt of the sense pins by the contacts by determining whether a closed electrical path exists between the sense pins and the contacts.

4. The system according to claim 2, wherein the sense pin of the circuit is electrically coupled to a pin having a predetermined setting, wherein the sense pin also has the predetermined setting through the electrical coupling and the detection mechanism detects the receipt of the sense pin by the contact by detecting the predetermined setting on the sense pin.

5. The system according to claim 4, wherein the predetermined setting is a supply voltage.

6. The system according to claim 1, wherein the circuit includes at least two sense pins and the plurality of pins includes a first end and a second end and wherein one sense pin is positioned at the first end and another sense pin is positioned at the second end.

7. The system according to claim 1, wherein the connector is a zero insertion force connector.

8. The system according to claim 1, wherein the circuit is a flexible circuit.

9. The system according to claim 1, wherein the system is contained within a mobile communications unit.

10. A flexible circuit, comprising:
an end that is received by a connector; and
a plurality of pins at the end, wherein at least one of the pins is a sense pin, wherein the sense pin is shorter than a number of the remaining pins, wherein if the sense pin is received by a contact in the connector, the flexible circuit is acceptably received by the connector.

11. The flexible circuit according to claim 10, wherein the flexible circuit includes at least two sense pins that are electrically coupled together to enable the determination of whether the sense pin is received by the contact.

12. The flexible circuit according to claim 10, wherein the sense pin is electrically coupled to a pin having a predetermined setting, wherein the sense pin also has the predetermined setting through the electrical coupling to enable the determination of whether the sense pin is received by the contact.

13. The flexible circuit according to claim 12, wherein the predetermined setting is a supply voltage.

14. The flexible circuit according to claim 10, wherein the flexible circuit includes at least two sense pins and the plurality of pins includes a first end and a second end and wherein one sense pin is positioned at the first end and another sense pin is positioned at the second end.

15. The flexible circuit according to claim 10, wherein the connector is a zero insertion force connector.

16. A method of determining whether a circuit is properly engaged with a connector, comprising:
coupling an end of a flexible circuit having a plurality of pins, at least one of which being a sense pin having a length shorter than a number of the remaining pins, to a connector having a set of contacts corresponding to the pins of the flexible circuit; and
determining whether the contact receives the sense pin, wherein when the contact receives the sense pin, the coupling between the flexible circuit and the connector is deemed sufficient.

17. The method according to claim 16, wherein the flexible connector includes at least two sense pins and wherein determining whether the contact receives the sense pin comprises determining whether a closed electrical path exists between the sense pins and the contacts.

18. The method according to claim 16, wherein the sense pin of the circuit is electrically coupled to a pin having a predetermined setting, wherein the sense pin also has the predetermined setting through the electrical coupling and wherein determining whether the contact receives the sense pin comprises detecting the predetermined setting on the sense pin.
